(19) United States
(12) Patent Application Publication
(10) Pub. No.: US 2007/0247105 A1
(43) Pub. Date: Oct. 25, 2007

(54) Portable battery charger

(75) Inventors: Michael Krieger, Miami Beach, FL (US); Kevin Ellsworth, Alva, FL (US)

Correspondence Address: VECTOR PRODUCTS, INC.;ROBERT POWELL, P.O. BOX 34385, c/o VENABLE LLP, WASHINGTON, DC, 20043-9998, US

(73) Assignee: Black & Decker Inc., Newark, DE (US)

(21) Appl. No.: 11/710,450

(22) Filed: Feb. 26, 2007

Related U.S. Application Data
(60) Provisional application No. 60/776,238, filed on Feb. 24, 2006.

(51) Int. Cl. H02J 7/00

(52) U.S. Cl. 320/104; 320/103; 320/110

(57) ABSTRACT

A battery charger is provided. The battery charger may be designed as a versatile, portable battery charger addressing the most common needs of power for a consumer. The battery charger preferable can provide DC power, AC power, vehicular battery charging capability, portable battery charging capability, and other power providing capabilities.

### BACKGROUND OF THE INVENTION

Batteries are used to provide power in an increasingly mobile society. Batteries provide power for starting vehicles. Exasperating inconvenience is experienced in finding a battery run down in attempting to start a vehicle. A good deal of delay is experienced in seeking a service to give the battery a charge. Certain danger exists in hooking up a jumper cable having the conventional alligator clamps for connection. An incorrect polarity connection can result in creating sparks and the risk of a battery explosion is ever present. Consequently, vehicular battery chargers have been developed to address these problems.

Many portable electronic devices also rely on one or more single-cell batteries for power. The plethora of different electronic devices, such as pagers, cellular phones, portable radios, portable CD players, flashlights, and other battery powered electronic equipment in use has created a great volume demand for single-cell battery power, resulting in the sale of both rechargeable and non-rechargeable single-cell batteries.

Rechargeable cells, such as nickel-cadmium cells, have a relatively constant potential during discharge and can be recharged many times, thus extending their useful life. In general, any rechargeable cell contains a combination of active materials which can be electrolytically oxidized and reduced repeatedly. In rechargeable cells, reactions at both electrodes are reversible and the input of current in the appropriate direction from an outside source will reverse the discharge reaction and, in effect, recharge the electrodes.

The rechargeable cells have been used in various type devices, such as toys, calculators, radios and other types of power-operated devices. Many of the power-operated devices on the market today have been designed to accommodate cylindrical cells of the “AA”, “C”, and “D” size. These sizes have now become standard-type cell sizes having overall dimensions which can be found in various publications, such as The American National Standard Specifications For Dry Cell Batteries—ANSI C18.1-1969 published by the American National Standards Institute, Inc., New York, N.Y.

Rechargeable batteries are available in conventional and identical sizes and substantially identical voltages as the non-rechargeable single cell batteries and are often used interchangeably with non-rechargeable batteries. The interchangeable use of either rechargeable or non-rechargeable small single cell batteries creates a problem for the user to distinguish between the rechargeable or non-rechargeable batteries, especially when dealing with a battery charger. To insert a non-rechargeable battery into a single cell battery charger creates a hazardous condition that can result in injury or damage due to leakage of chemicals from the non-rechargeable battery when recharging is accidentally attempted.

Applicant knows of no single device that can provide vehicular battery charging capability as well as portable battery charging capability. Thus, there is a need for a device that can address the power needs generated by consumer power requirements.

### SUMMARY OF THE INVENTION

In an exemplary embodiment of the invention, a battery charger is provided. The battery charger may be designed as a versatile, portable battery charger addressing the most common needs of power for a consumer. The battery charger preferably may provide vehicular battery charging capability and portable battery charging capability, and other power providing capabilities.

In an exemplary embodiment of the invention, the portable vehicle battery charger comprises a housing; a DC outlet provided on the housing; an internal battery disposed within the housing and coupled to the DC outlet; vehicular battery charging circuitry disposed in the housing; portable battery charger circuitry disposed in the housing, the portable battery charger circuitry providing charging current to the internal battery and/or to portable batteries inserted into the housing.

### BRIEF DESCRIPTION OF THE DRAWINGS

FIG. 1 is a perspective view of an exemplary embodiment of a portable vehicle battery charger according to the invention;

FIG. 2 is a block diagram illustrating the components of the portable battery charger according to an exemplary embodiment of the invention; and

FIG. 3 is a more detailed view of the charger of FIG. 1.

### DETAILED DESCRIPTION

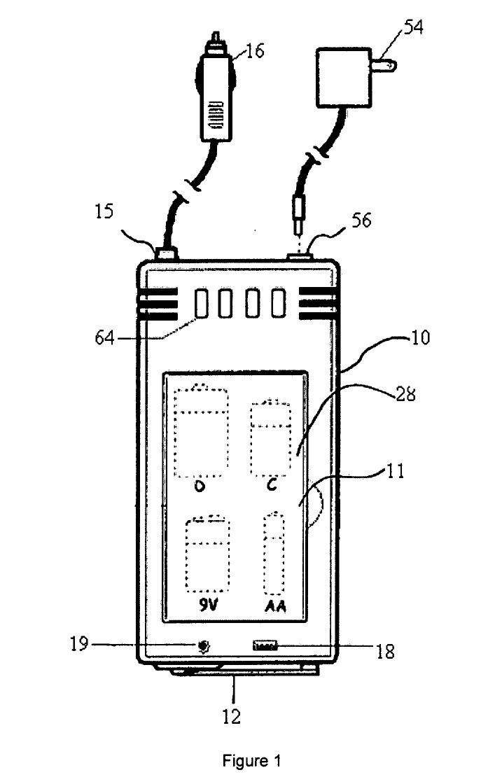

The portable battery charger shown in FIGS. 1-3, includes a housing 10. A power source, for example a battery 20, such as a sealed lead acid battery, a nickel cadmium battery, a nickel metal hydride battery or the like, may be disposed in the housing 10. A hand cranked dynamo 12 may also be provided. The dynamo 12 may provide power, for example to recharge the battery 20, in the event of a power outage or if power is otherwise unavailable. Additionally, the battery 20 can provide power for a controller 14, such as a microprocessor or other circuitry, that is used to control the operation of the various components of the portable battery charger. The battery 20 may also provide power to a household battery charger 40. The battery 20 may also provide a portable DC power source that can be used to operate various external devices when other power sources are not available.

Several different types of DC power outlets may be provided. For example, USB port 18 may be provided on the housing. The USB port 18 may be used to provide a USB power supply. In embodiments of the invention, a voltage regulator, optionally included in the USB port 18, may convert DC input power, for example, from a 12 V DC input or the battery 20, into a USB compatible 5V/500 mA DC power output. A charging port 19 (FIG. 1) for mobile telephones or other portable devices may also be provided. In embodiments of the invention, the DC power outlets may be adapted to receive power from the dynamo 12, battery 20, or a DC power input.

The housing 10 may be provided with at least one DC power input port. For example, DC power may be provided via a cigarette lighter or accessory outlet in a vehicle. A DC input port 15 on housing 10 may be connected to a cigarette lighter plug 16. Also, DC input port 56 may be provided on the housing 10 to receive input from a wall cube 54. The wall cube 54 converts household AC current into DC current.

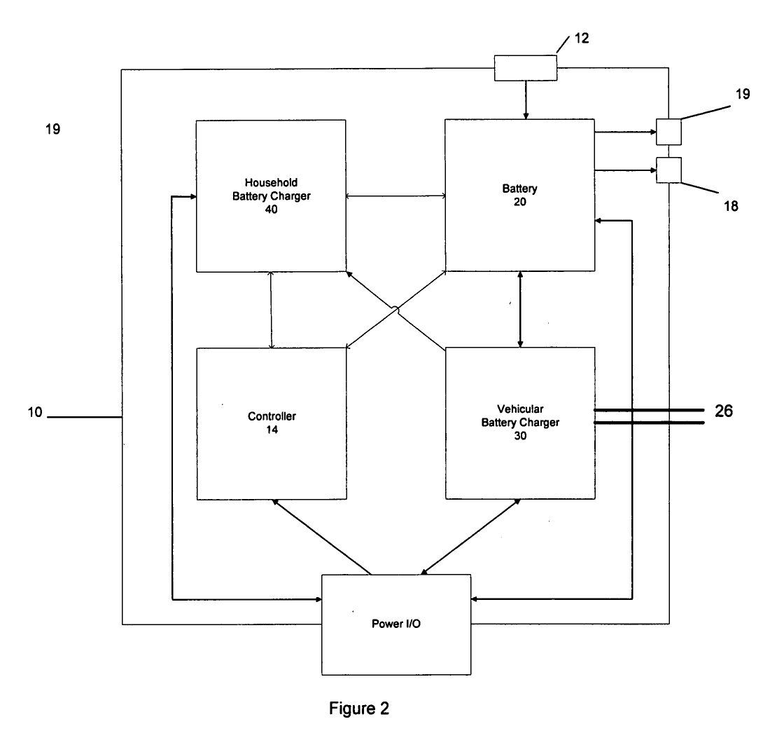

The portable battery charger may also be provided with vehicular battery charger circuitry 30 (FIG. 2). The vehicular battery charger circuitry 30 may be adapted to provide charging power for the battery 20, the household battery charger 40, and to external batteries, such as a vehicular battery. The battery charger circuitry 30 may be a high frequency charger, such as the high frequency charger disclosed in U.S. Pat. No. 6,822,425, filed Oct. 15, 2002, which is incorporated herein by reference, or other known vehicular battery charging circuitry.

The vehicular battery charger circuitry 30, within the portable battery charger, may be coupled to an external vehicle battery via jumper cables 26, which are coupled to a DC power input port, and may output a DC power signal that can be used to charge an external battery. Alternatively, the output power signal may be provided to the battery 20 internal to the housing 10 for charging thereof.

The vehicular battery charger circuitry 30 may include many of the features described in U.S. Pat. No. 6,822,425, filed Oct. 15, 2002, such as an alternator check function, fault codes, a battery recondition mode, a cold cranking amps (CCA) read out, and others. A battery gauge such as a linear meter for a digital read out or a bar graph can be provided to display to the user the status of the internal and/or the external battery being charged.

The housing 10 may be provided with a lid 11 (FIG. 1). The lid 11 may be opened or closed to expose or enclose a cavity 28 within the housing 10. Latches or other securing devices may be provided to secure the lid 11 in the closed position. Portable battery charger circuitry 40 may also be provided. The battery charger circuitry 40 may be adapted to charge portable rechargeable batteries, such as NiCad batteries and the like.

The cavity 28 may be adapted to accommodate portable batteries of different size and type, such as a 9 volt battery and D, C, AA, etc. size cells. As defined herein, portable batteries comprise any rechargeable portable battery designated as such by any of the American National Standard Specifications as published by the American National Standards Institute, such as ANSI C18 series. Exemplary portable batteries are designated as AAA, AA, C and D and have wide household use.

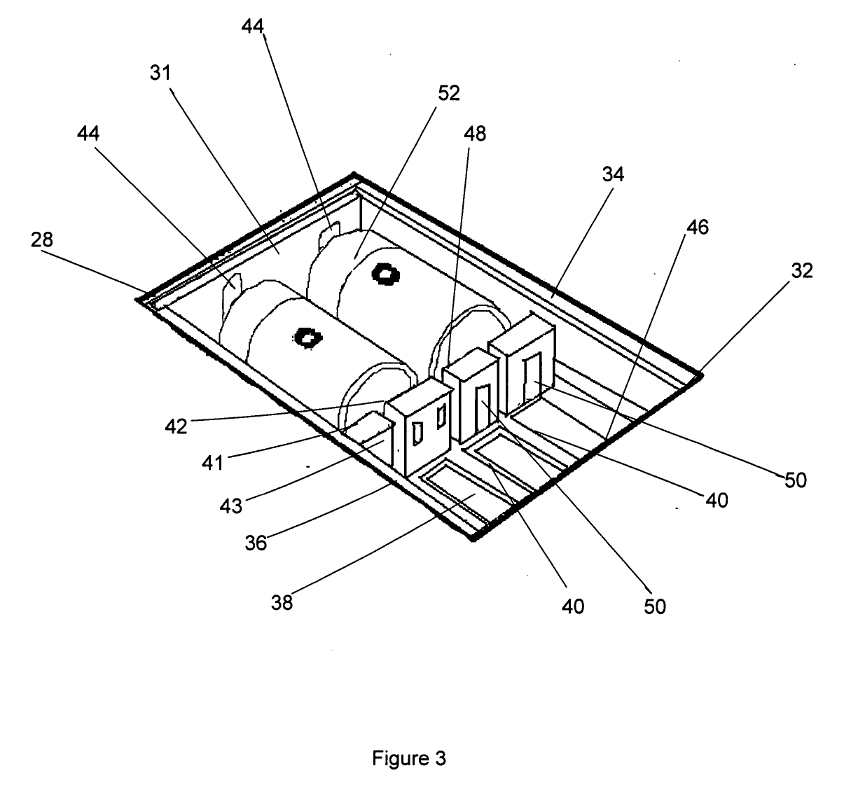

As shown in FIG. 3, the cavity 28 has a rectangular shape, with a top 31, bottom 32 and two sides 34, 36. A back 38 connects the top 31, bottom 32 and two sides 34, 36 together. The top 31 and bottom 32 may be provided with various contacts 44, 46, respectively, to connect to the contacts of different size and type batteries. Back 38 may be provided with slots 40 extending along at least part of its length or width. A slide member 41 moves along the slots 40.

The slide member 41 has a front surface 42 facing top 31 and a back surface 43 facing bottom 32. Various sets of contacts 48, 50 are provided on front surface 42 and back surface 43 respectively. The contacts 48, 44 on front surface 42 and top 31, respectively, are adapted to connect to battery electrodes of opposite polarity. The contacts 50, 46 on back surface 43 and bottom 32, respectively, are adapted to connect to battery electrodes of opposite polarity. For example, positive electrodes of batteries 52 are connected to contacts 44 and negative electrodes of batteries 52 are connected to contacts 48 on front surface 42. The slide member 41 may move along the slots to fit different size batteries. Cavity 28 may also be adapted to receive and charge batteries of different sizes in a variety of other ways which are known to one of ordinary skill in the art.

Additionally, the portable battery charger circuitry 40 may detect if rechargeable or non-rechargeable batteries are placed in the cavity 28. Detection may be made by controller 14. The detection may be based on the characteristics of the portable battery, such as voltage, internal resistance, etc. If a non-rechargeable battery is detected, charging is prevented. Detecting and preventing the charging of non-rechargeable batteries may be done in a known manner.

The portable batteries may be charged with power from a DC input port, the vehicular battery charger 30, or the battery 20. Internal battery 20 may be charged via DC input power, vehicular battery charger circuitry 30, or portable battery charger circuitry 40.

An on/off switch controls the operation of the vehicle battery charger. A set of indicator lights 64 may be provided to show the status of the internal battery 20 or portable batteries being charged. The controller 14 may monitor the various components of the vehicle battery charger and show results on a display. The display may include a linear meter, a digital read out or a bar graph for a user to monitor the operation of the vehicle battery charger.

Numerous different options are contemplated within the apparatus electrically, these options may include such schemes as totally enclosing the internal wiring terminating at a single point input/outlet for all charging functions or, conversely, at multiple points both internal and external. The power inverter, battery charger and other devices may be of varying watts, amperage ratings, etc. The battery configuration may include several different types of technology such as nickel cadmium, lead acid, etc. A port may be provided in the vehicle battery charger to allow for the addition of external batteries of greater capacity than the internal battery. Each of the aforementioned devices are contained within the same housing for a portable vehicle battery charger. The vehicle battery charger can provide both DC and AC power in addition to battery charging capabilities.

We claim:

1. A portable battery charger, comprising:
a housing defining a cavity therein, the cavity being adapted to receive different size rechargeable batteries;
at least one DC input port;
a battery disposed within the housing;
vehicular battery charger circuitry disposed in the housing and coupled to the DC input port; and
a portable battery charging circuitry disposed in the housing, the portable battery charger circuitry coupled to at least one of the DC input and the internal battery and providing battery charging current to portable batteries in the cavity.

2. The portable battery charger of claim 1, wherein the portable battery charging circuitry is adapted to distinguish between rechargeable and non-rechargeable batteries.

3. The portable battery charger of claim 1, further comprising:
a lid hingedly connected to the housing and adapted to cover the cavity;
a slide member disposed in the cavity, the slide member being movable to accommodate different size portable batteries;
a first set of recharging contacts disposed on a top side of the cavity and a corresponding set of battery contacts provided on a first side of the slide member; and
a second set of recharging contacts disposed on a bottom side of the cavity and a corresponding set of battery contacts provided on a second side of the slide member, opposite the first side of the slide member.

4. The portable battery charger of claim 1, further comprising:
a hand cranked dynamo coupled to the battery.

5. The portable battery charger of claim 1 further comprising a controller connected to the vehicular battery charger circuitry, the portable battery charging circuitry, and the battery.

6. The portable battery charger of claim 1, further comprising a cigarette lighter adaptor coupled to one of the DC input ports.

7. The portable battery charger of claim 6 further comprising at least one DC output port.

8. The portable battery charger of claim 7, wherein the DC output port is adapted to output a USB compatible power output.

9. The portable battery charger of claim 7 wherein the DC output port is adapted to charge a mobile telephone.

10. The portable battery charger of claim 2, wherein the portable battery charging circuitry is adapted to charge only chargeable batteries.

11. The portable battery charger of claim 1, wherein the vehicular battery charger is coupled to the at least one DC output port.

12. The portable battery charger of claim 11, further comprising:
a set of jumper cables coupled to the vehicular battery charger circuitry.

13. The portable battery charger of claim 1, further comprising:
a first set of indicator lights configured to indicate the status of at least one of the vehicular battery charger, or the portable battery charger.

14. The portable battery charger of claim 1, further comprising:
a second set of indicator lights configured to indicate the status of at least one of the battery, the portable batteries, or the vehicular battery.

15. The portable battery charger of claim 1, further comprising:
a display connected to the vehicular battery charger circuitry.

16. The portable battery charger of claim 3, wherein the first and second set of recharging contacts are configured to receive battery electrodes of opposite polarities.

17. An apparatus, comprising:
a housing; and
circuitry disposed within the housing coupled to a battery, a portable battery charger, a vehicular battery charger, a controller, at least one of a AC or DC input port, and at least one of an AC or DC output port:
the battery adapted to receive a DC input from the DC input port or the vehicular battery charger and provide a DC output, and coupled to the controller, the portable battery charger, and at least one of the DC output ports;
the vehicular battery charger adapted to receive a DC input from at least one of the DC input ports or the battery, and provide a DC ouput, and coupled to the controller, the battery, and the portable battery charger, and at least one of the DC output ports;
the portable battery charger adapted to receive a DC input from at least one of the battery, the DC input port, or the vehicular battery charger, to contain at least one rechargeable battery and provide DC input to the at least one rechargeable battery; and
the controller adapted to receive DC input from at least one of the battery, the DC input port, or the vehicular battery charger, regulate the operation of the battery, the portable battery charger, and the vehicular battery charger.

18. The apparatus of claim 17, wherein the battery charger is adapted to distinguish between rechargeable and non-rechargeable batteries.

19. The apparatus of claim 17, further comprising:
a lid hingedly connected to the housing and adapted to cover the cavity, the lid including contours adapted to fit the contour of different size batteries to hold the batteries within the cavity.

20. The apparatus of claim 17, further comprising:
a lid hingedly connected to the housing and adapted to cover the cavity;
a slide member disposed in the cavity, the slide member being movable to accommodate different size portable batteries;
a first set of recharging contacts disposed on a top side of the cavity and a corresponding set of battery contacts provided on a first side of the slide member; and
a second set of recharging contacts disposed on a bottom side of the cavity and a corresponding set of battery contacts provided on a second side of the slide member, opposite the first side of the slide member.

21. The apparatus of claim 17, further comprising a cigarette lighter adaptor coupled to the DC input port.

22. The apparatus of claim 17, further comprising a USB port configured to output DC power.

23. The apparatus of claim 17 further comprising a set of indicator lights disposed on the housing configured to indicate the status of the least one of the battery, the portable battery charger, or the vehicular battery charger.

24. The apparatus of claim 17 further comprising a set of indicator lights configured disposed on the housing to indicate the status of at least one of the battery, the portable batteries, or the vehicular battery being charged.

25. The apparatus of claim 17 further comprising a display disposed on the housing configured to indicate the status of at least one of the battery, the portable battery charger, or the vehicular battery charger.
